(19) United States
(12) Patent Application Publication
(10) Pub. No.: US 2024/0120700 A1
(43) Pub. Date: Apr. 11, 2024

(54) CO2 BEAM SOURCE COMPRISING A CATALYST

(71) Applicant: TRUMPF Lasersystems for Semiconductor Manufacturing GmbH, Ditzingen (DE)

(72) Inventors: Jonathan MUELLER, Stuttgart (DE); Fabian GIUNTA, Burladingen (DE); Morris DAHLINGER, Murrhardt (DE); Markus KARL, Stuttgart (DE)

(21) Appl. No.: 18/542,802

(22) Filed: Dec. 18, 2023

Related U.S. Application Data
(63) Continuation of application No. PCT/EP2021/066414, filed on Jun. 17, 2021.

(30) Foreign Application Priority Data
Jun. 17, 2021 (WO) PCT/EP2021/066414

(51) Int. Cl. H01S 3/036; H01S 3/04; H01S 3/041; H01S 3/223

(52) U.S. Cl. CPC H01S 3/036; H01S 3/0407; H01S 3/041; H01S 3/2232

(57) ABSTRACT

A CO₂ beam source includes a discharge tube in which a laser gas serves as a laser medium, a fan for supplying the laser gas into the discharge tube via a supply element and for removing the laser gas from the discharge tube via a removal element in a closed laser gas circuit, and a catalyst for catalysing oxidation of dissociation products formed upon excitation of the laser gas. The catalyst includes precious metal nanoparticles applied to a substrate. The catalyst is arranged with clearance from the discharge tube in the flow direction of the laser gas within the closed laser gas circuit in order to reduce deposition of degradation products formed in the discharge tube upon excitation of the laser gas compared to an arrangement within the discharge tube. A temperature of the at least one catalyst during operation of the CO₂ beam source is at least 60° C.

### CROSS REFERENCE TO RELATED APPLICATIONS

This application is a continuation of International Application No. PCT/EFP2021/066414 (WO 2022/262980 A1), filed on Jun. 17, 2021, and claims benefit to PCT/EP2021/066414 (WO 2022/262980 A1), filed on Jun. 17, 2021. The aforementioned application is hereby incorporated by reference herein.

### FIELD

Embodiments of the present invention relate to a CO₂ beam source comprising: at least one discharge tube in which a laser gas serves as a laser medium, a fan for supplying the laser gas into the at least one discharge tube via at least one supply element and for removing the laser gas from the at least one discharge tube via at least one removal element in a closed laser gas circuit, and at least one catalyst for catalyzing oxidation of dissociation products which are formed upon excitation of the laser gas, wherein the at least one catalyst comprises precious metal nanoparticles applied to a substrate.

### BACKGROUND

In the context of this application, a CO₂ beam source is understood to mean a CO₂ laser or a CO₂ laser amplifier. In the latter case, the CO₂ laser amplifier is typically used to amplify a seed laser beam emitted by a seed laser. The laser gas of a CO₂ beam source is typically a mixture of He, N₂ and CO₂. The CO₂ serves as the actual laser medium, and the He and N₂ molecules have a supporting role. A CO₂ beam source is excited electrically. To this end, the laser gas is excited in the discharge tube, typically a quartz glass tube, via a gas discharge at high DC voltage or high-frequency AC voltage. The excitation leads to a population inversion. In the case of a CO₂ beam source in the form of a CO₂ laser, the laser medium is situated in the beam path of a mirror arrangement acting as a laser resonator.

Since the laser gas heats up greatly during operation of the CO₂ beam source and the laser process, however, comes to a standstill at temperatures above 300° C., it is necessary to cool the laser gas. Removing the laser gas from the discharge tube and returning the laser gas into the discharge tube in a closed laser gas circuit allows such cooling via suitable additional devices, for example via heat exchangers.

CO₂ beam sources in the form of CO₂ laser amplifiers are used in particular for the generation of EUV radiation. The term EUV radiation refers to electromagnetic radiation having a wavelength of between 10 nm and 120 nm. Compared with the currently widespread use of wavelengths around 200 nm, the use of EUV radiation for microlithographic fabrication in the semiconductor industry allows the reliable production of components with significantly smaller feature sizes and thus leads to a corresponding increase in performance. In the so-called LPP process (“Laser Produced Plasma”), the EUV radiation is generated by bombarding tin droplets with laser pulses which were amplified in a CO₂ laser amplifier. The bombardment of the tin droplets results in the formation of a plasma which emits the EUV radiation.

A particular challenge for the design of CO₂ beam sources is posed by the formation of dissociation products due to the gas discharge when the laser gas is excited. Said dissociation products, including carbon monoxide (CO) in particular, lead to a drop in the power and efficiency of the laser or laser amplifier. A countermeasure described in the literature is the use of catalysts for oxidation of the dissociation products, in particular for oxidation of CO to CO₂.

U.S. Pat. No. 4,756,000 discloses a CO₂ laser having a closed laser gas circuit, a CO₂ laser gas mixture and an amplification volume. A gas discharge in the amplification volume results in the formation of CO, oxygen, and excited oxygen species. A gold coating serves as a catalyst for the reaction of the CO with the excited oxygen to form CO₂. The gold coating is arranged on a wall of the amplification volume or sufficiently near the downstream end of the amplification volume in order to ensure contact with a substantial amount of the excited oxygen. A disadvantage of such an arrangement is that, owing to the gas discharge, deposition effects of degradation products formed when laser gas is excited occur in the amplification volume and immediately downstream of the amplification volume, which is associated with degradation of the catalyst and consequently a drop in power of the CO₂ laser.

DE 3523926 C2 describes an electrically excited CO₂ laser having a closed laser gas circuit and a catalyst for producing and maintaining the chemical composition of the laser gas, wherein an additional radiation source serves to substantially increase the attachment of molecules formed by dissociation in the laser gas to the catalyst and/or wherein the gas flow around the catalyst surface is controlled in such a way that the attachment of the molecules formed by dissociation in the laser gas to the catalyst is substantially increased.

JPS6214486A describes a CO₂ laser having a catalyst unit which keeps the composition of the laser gas constant and thus the output power of the laser stable. For this purpose, the catalyst unit is simultaneously in the form of a self-regulating heating unit, by means of which the temperature of the catalyst unit is automatically kept within a range in which the oxidation rate of CO is constant.

US 2015/0222083 A1 describes an EUV system including an optical amplifier system with a catalyst. In one embodiment, the catalyst comprises a substrate which has openings and also comprises nanoparticles of a precious metal, for example of gold, which are applied as a coating to the interior surfaces of the openings. It is stated that the temperature of the gas mixture in the catalyst can rise to up to 60° C. if the catalyst is arranged in an amplifier of the optical amplifier system or in a CO₂ laser.

The oxidation of CO by means of catalysts based on small gold particles is also discussed in detail in the article “Gold-Catalysed Oxidation of Carbon Monoxide” by G. C. Bond and D. T. Thompson, Gold Bull. 33, 41 (2000).

### SUMMARY

Embodiments of the present invention provide a CO₂ beam source. The CO₂ beam source includes at least one discharge tube in which a laser gas serves as a laser medium, a fan for supplying the laser gas into the at least one discharge tube via at least one supply element and for removing the laser gas from the at least one discharge tube via at least one removal element in a closed laser gas circuit, and at least one catalyst for catalysing oxidation of dissociation products that are formed upon excitation of the laser gas. The at least one catalyst includes precious metal nanoparticles applied to a substrate. The at least one catalyst is arranged with clearance from the at least one discharge tube in the flow direction of the laser gas within the closed laser gas circuit in order to reduce deposition of degradation products formed in the at least one discharge tube upon excitation of the laser gas compared to an arrangement within the at least one discharge tube. A temperature of the at least one catalyst during operation of the CO₂ beam source is at least 60° C.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a top view of a CO₂ beam source in the form of a CO₂ laser with a folded laser resonator in a sectional view according to some embodiments;

FIG. 2 shows a perspective view of the CO₂ beam source shown in FIG. 1 in the form of a CO₂ laser with catalysts arranged in supply arms and removal arms of the CO₂ beam source, according to some embodiments; and

FIG. 3a, b, c show schematic illustrations of catalysts, the substrates of which have different structures for surface area enlargement, according to some embodiments.

Detailed Description Embodiments of the invention provide a CO₂ beam source which exhibits high and long-term stable power and efficiency.

According to a first aspect, a CO₂ beam source is provided, in which the at least one catalyst is arranged with clearance from the at least one discharge tube in the flow direction of the laser gas within the closed laser gas circuit in order to reduce deposition of degradation products formed in the at least one discharge tube upon excitation of the laser gas compared to an arrangement within the at least one discharge tube, and in which a temperature of the at least one catalyst during operation of the CO₂ beam source is at least 60° C., preferably at least 100° C. and preferably at least 150° C.

The gas discharge used to excite the laser gas causes degradation of the walls of the at least one discharge tube. The degradation products formed in the process are deposited in the at least one discharge tube and in the laser gas circuit adjacently downstream of the at least one discharge tube. Since the discharge tubes are generally quartz glass tubes, the degradation products typically comprise quartz particles, in particular in the form of dust. If the degradation products are deposited on the at least one catalyst, its effectiveness will drop and the concentrations of the dissociation products in the closed laser gas circuit will increase. This will result in a drop in output power and efficiency of the CO₂ beam source. It is therefore advantageous to arrange the catalyst with clearance from the at least one discharge tube in the flow direction of the laser gas within the closed laser gas circuit. An appropriate arrangement leads to continuously high performance of the CO₂ beam source and thus allows long maintenance intervals.

When choosing the catalyst, it should be noted that excited, free-radical and/or atomic oxygen is present in a significant concentration only in the discharge tube or immediately adjacently downstream of the discharge tube. The option of an arrangement with sufficient clearance with respect to the deposition of the degradation products is therefore only available with use of catalysts which catalyze not only the oxidation of dissociation products, in particular CO, with transient oxygen species, for example atomic, free-radical and/or excited oxygen, but also the oxidation with molecular oxygen. Suitable here are catalysts based on precious metal nanoparticles, in principle even at room temperature.

In general, the effectiveness of a catalyst increases as the temperature increases. However, in the closed circuit of the CO₂ beam source, high temperatures occur primarily in the discharge tubes and adjacently downstream of the discharge tubes. As a function of the distance from the discharge tubes, the temperatures typically continuously fall in the flow direction of the laser gas owing to cooling. When choosing the arrangement of the catalyst, a balance can therefore be made between a reduction of the deposition effects and the highest possible temperature. The temperature ranges stated allow the effective catalysis of the oxidation of CO to CO₂ with molecular oxygen by means of precious metal nanoparticle catalysts and are achieved in CO₂ beam sources of sufficiently high power even at a sufficient distance from the discharge tubes.

In principle, it is also possible to output part of the laser gas flow from the actual laser gas circuit and to pass it through a separate catalyst unit comprising a conventional catalyst based on a homogeneous platinum or palladium layer. Such conventional catalysts also allow the reaction of CO to CO₂ with molecular oxygen, but require temperatures above approx. 250° C. for this purpose. For CO₂ beam sources, such high temperatures are counterproductive for the actual laser process and therefore generally undesirable. Such a catalyst unit would therefore have to be heated, i.e., it would have to comprise a heater, cooler and optionally its own fan (gas pump) in addition to the catalyst. The structural complexity for such a catalyst unit is therefore very high, especially if a significant proportion of the laser gas flow is to pass through this catalyst loop. Furthermore, the additional heating undermines the actual purpose of the circuit, namely the cooling of the laser gas. Temperatures of more than 250° C. may be reached in CO₂ beam sources immediately downstream of the discharge tubes even without additional heating. However, since the deposition effects are most pronounced here, it is not appropriate to arrange a conventional catalyst in this region.

In one embodiment, a flow path of the laser gas between a downstream end of the at least one discharge tube and the at least one catalyst is at least 5 cm, preferably at least 10 cm and preferably at least 15 cm. It has been found that the deposition effects fall substantially exponentially as a function of the flow path from the downstream end of the at least one discharge tube. The half-life length is a few centimeters. The distance values stated thus lead to an effective reduction in the deposition of degradation products on the at least one catalyst.

In a further embodiment, the at least one catalyst is arranged within at least one of the supply elements. Such an arrangement generally ensures a sufficient clearance from the discharge tube, since the flow path from the downstream end of the discharge tube up to the supply element is sufficiently great. However, in principle, the catalyst can also be arranged within at least one of the removal elements.

In a further embodiment, the fan is centrally arranged and, in a first plane, the CO₂ beam source comprises supply arms as first supply elements and removal arms as second removal elements in a radial and alternating manner and, in a second plane, the discharge tubes are interconnected via second supply elements and first removal elements in an alternating manner, wherein at least one partial region of at least one supply arm and/or at least one removal arm is in the form of a heat exchanger for cooling of the laser gas. The CO₂ beam source is, for example, substantially discretely rotationally symmetrical, preferably fourfold rotationally symmetrical. Starting from the (radial) fan, the laser gas is supplied to the discharge tubes by means of the supply arms and the second supply elements and removed from the discharge tubes to the fan again by means of the first removal elements and the removal arms. Such a construction results in short gas paths between the discharge tubes and the heat exchangers and is distinguished by its compactness and its robustness, for example against jolts or vibrations. At the same time, this achieves very high laser powers. For even higher laser powers, the second plane can also have two or more subplanes of discharge tubes that are interconnected via the second supply elements and the first removal elements. In order to form at least one partial region of at least one supply and/or removal arm as a heat exchanger, at least one cooling tube, for example helical cooling tube, can for example be passed through the corresponding partial region. The laser gas is cooled by conducting a cooling liquid through the cooling tube.

In one development of this embodiment, at least one inner face of at least one supply arm in contact with the laser gas serves as substrate of the at least one catalyst. Alternatively, an outer face of the cooling tube, for example helical cooling tube, in contact with the laser gas can also serve as substrate of the at least one catalyst. Alternatively, an inner face of at least one removal arm in contact with the laser gas and/or an outer face of a cooling tube in contact with the laser gas, which cooling tube passes through the corresponding partial region of the removal arm, can also serve as substrate of the at least one catalyst.

In a further embodiment, the at least one catalyst is arranged in at least one of the supply arms and/or in at least one of the removal arms upstream of the at least one partial region in the form of a heat exchanger. An advantage of such an arrangement is that the temperatures upstream of the partial regions in the form of a heat exchanger are comparatively high. They are typically between approx. 150° C. and approx. 250° C. upstream of the partial regions of the removal arms in the form of a heat exchanger and between approx. 60° C. and approx. 100° C. upstream of the partial regions of the supply arms in the form of a heat exchanger. At the same time, this arrangement is distinguished by a sufficient distance of the flow path of the laser gas from the discharge tubes and by good accessibility. Moreover, proceeding from CO₂ beam sources that are currently produced, only minimal structural adaptations are necessary in order to arrange the catalyst therein.

In a further embodiment, the CO₂ beam source comprises at least one device for replacing the at least one catalyst. Although the arrangement of the catalyst in accordance with embodiments of the invention leads to a distinct reduction in the deposition of degradation products on the catalyst, certain aging effects nevertheless do occur. It is therefore advantageous if the catalyst is as simple to replace as possible. For this purpose, the catalyst is preferably in the form of a separate component and is thus simple to insert into a corresponding housing in the closed circuit and simple to take out again. As a result, maintenance is simple and the CO₂ laser is only temporarily out of service during maintenance.

In one development of this embodiment, at least one supply arm and/or at least one removal arm comprises at least one closable opening as a device for replacing the at least one catalyst. In this case, the at least one catalyst is arranged in at least one of the supply arms and/or in at least one of the removal arms. Via closable openings in the corresponding supply or removal arms, the catalyst can be inserted and taken out again. The closable openings are, for example, flaps or plates that can be hermetically sealed via suitable screw fittings and by means of appropriate gaskets, for example using O-rings. The closable openings should be larger than the cross-section of the respective catalyst, so that it can be taken out in a linear motion and is easily accessible from the outside. It is advantageous to combine the design of the catalysts as separate components with an arrangement in the supply and/or removal arms upstream of the partial regions in the form of a heat exchanger and with a replaceability of the catalysts via closable openings in the supply and/or removal arms. In comparison with use of the outer faces of the cooling tubes, for example helical cooling tubes, of the heat exchangers as substrates of the catalysts, it is precisely the functional separation between the catalysts and the heat exchangers that allows simple replacement.

In a further embodiment, the precious metal nanoparticles are platinum nanoparticles, palladium nanoparticles, gold nanoparticles, nanoparticles of an alloy of these materials, or a mixture of these nanoparticles. Compared to conventional catalysts, catalysts based on precious metal nanoparticles are in general much more efficient, as measured by the turnover of the catalyst in relation to its surface area. It has been found that the precious metal nanoparticles stated, in particular gold nanoparticles and/or platinum nanoparticles, are suitable for the present application.

In a further embodiment, the substrate of the at least one catalyst is a metal substrate or a ceramic substrate. The metal can be, for example, steel or stainless steel, and the ceramic can be, for example, cordierite.

In a further embodiment, a coating is present on the substrate of the at least one catalyst and the precious metal nanoparticles are applied to said coating, wherein the coating preferably comprises a metal oxide and preferably comprises cerium oxide, aluminum oxide, titanium oxide, copper oxide or a mixture of these materials. In this case, the precious metal nanoparticles are applied directly to the coating and thus indirectly to the substrate via the coating. The substrate serves here as a mechanical support for the chemically active part of the catalyst, which comprises the coating and the precious metal nanoparticles. The coating can be applied to the substrate by means of a suitable deposition method or can form by itself, for example via oxidation of a metal substrate.

In one development of this embodiment, the coating on the substrate of the catalyst is microscopically structured for surface area enlargement. In order to achieve the greatest possible turnover, what is advantageous is the largest possible surface area of the catalyst. Appropriate microscopic structuring can be achieved, for example, by deposition of the coating as particles from a suspension.

In a further embodiment, the substrate of the catalyst is structured for surface area enlargement. In addition to or as an alternative to the microscopic structuring of the coating, surface area enlargement can also be achieved via structuring of the substrate of the catalyst. To this end, the substrate can be, for example, a pultruded profile. The cross-section can have a regular pattern, for example square pattern. Alternatively, the substrate can also be a rolled-up corrugated sheet.

In one development of this embodiment, the substrate of the catalyst is honeycomb-structured for surface area enlargement.

Further features and advantages of the invention are evident from the following description of exemplary embodiments of the invention, with reference to the figures of the drawing, which show details essential to the invention, and from the claims. The individual features can be realized in each case individually by themselves or as a plurality in any desired combination in a variant of the invention.

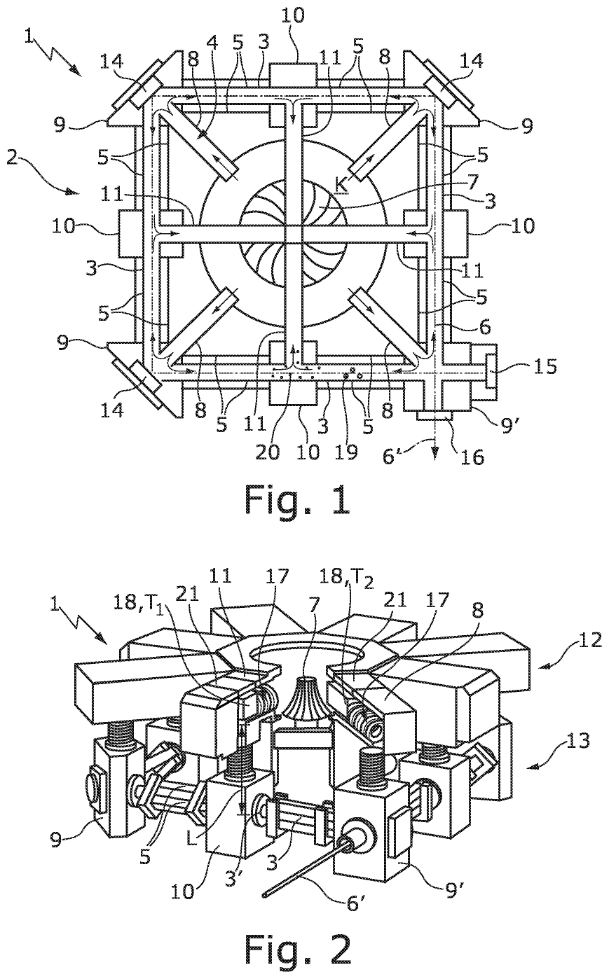

FIG. 1 and FIG. 2 show a CO₂ beam source 1 in the form of a CO₂ laser which comprises a square-folded laser resonator 2 and is substantially fourfold rotationally symmetrical. In discharge tubes 3, a laser gas 4 consisting of CO₂, He and N₂ and serving as a laser medium is excited via electrodes 5. The electrodes 5 are arranged adjacently to the discharge tubes 3 and connected to a HF generator not shown here. For example, the HF generator used can be a tube generator with an excitation frequency of 13.56 MHz or 27.12 MHz. The excitation of the laser gas 4 results in a population inversion and a laser beam 6 is formed in the laser resonator 2.

The laser gas 4 is cooled by removing it from the discharge tubes 3 by means of a fan 7 (radial fan) arranged centrally in the folded laser resonator 2 and returning it to the discharge tubes 3 in a closed laser gas circuit K after cooling has occurred. For this purpose, the CO₂ beam source 1 comprises, by way of example, four supply arms 8 as first supply elements and four second supply elements 9,9′, and four first removal elements 10 and four removal arms 11 as second removal elements.

The four supply arms 8 and the four removal arms 11 are arranged radially in a first plane 12 of the CO₂ beam source 1, whereas the discharge tubes 3 are arranged in a second plane 13 and are interconnected via the second supply elements 9,9′ and the first removal elements 10 in an alternating manner. The second supply elements 9,9′ form the corners of the square laser resonator 2, whereas the first removal elements 10 are arranged centrally along the edges of the square laser resonator 2.

The flow direction of the laser gas 4 inside the discharge tubes 3 and in the supply elements 8,9,9′ and the removal elements 10,11 is illustrated by arrows in FIG. 1. Starting from the fan 7, the laser gas 4 flows through the four supply arms 8 and the four second supply elements 9,9′ arranged in the corners of the square laser resonator 2 into the discharge tubes 3. Furthermore, the laser gas 4 flows through the discharge tubes 3 and via the first removal elements 10 and the removal arms 11 back to the fan 7.

The laser beam 6 runs along the axes of the discharge tubes 3. Deflection minors 14 in the second supply elements 9 serve to deflect the laser beam 6 by 90° in each case. Arranged in one of the second supply elements 9′ are a first resonator mirror 15 and a partially transmissive second resonator minor 16. The first resonator mirror 15 is highly reflective and reflects the laser beam 6 by 180°, so that the laser beam 6 passes through the discharge tubes 3 again in the opposite direction. The partially transmissive second resonator mirror 16 serves as an output mirror, via which one part 6′ of the laser beam 6 is coupled out of the laser resonator 2, whereas the other part remains in the laser resonator 2 and passes through the discharge tubes 3 again.

In contrast to what is illustrated here, the CO₂ beam source 1 can also have two subplanes of discharge tubes 3 that are interconnected via the second supply elements 9,9′ and the first removal elements 10 in order to increase power. The laser beam 6 is then, for example, redirected between the subplanes via periscopes.

Deviating from what is illustrated in FIG. 1 and FIG. 2, the CO₂ beam source 1 can also be a CO₂ laser amplifier. In this case, the resonator mirrors 15,16 are replaced by windows. A laser beam 6 to be amplified, for example in the form of a seed laser beam, then passes through the CO₂ beam source only once.

FIG. 2 depicts a supply arm 8 in a partial section and a removal arm 11 in a partial section. Formed inside the supply arms 8 and the removal arms 11 is, in each case, a partial region 17 in the form of a heat exchanger. In the CO₂ beam source shown by way of example in FIG. 2, the heat exchanger function is fulfilled by passing helical cooling tubes, through which a cooling liquid flows, through these partial regions 17. Arranged upstream of these partial regions 17 in a supply arm 8 and a removal arm 11 is, in each case, a catalyst 18 for catalyzing the oxidation of dissociation products 19 (cf. FIG. 1) which are formed when the laser gas 4 is excited, in particular the oxidation of CO. An advantage of this arrangement is the comparatively high catalyst temperatures with a simultaneously sufficient clearance from the discharge tubes 3. The temperature T₁ in the region of the catalyst 18 in the removal arm 11 is typically within a range of values between 150° C. and 250° C., whereas the temperature T₂ in the region of the catalyst 18 in the supply arm 8 is typically within a range of values between 60° C. and 100° C.

The clearance of the catalysts 18 from the discharge tubes 3 serves to reduce the deposition of degradation products 20 formed in the discharge tubes 3 upon excitation of the laser gas 4 (cf. FIG. 1) on the respective catalyst 18. A flow path L of the laser gas 4, which runs substantially vertically here, between the downstream end 3′ of the discharge tube 3 and the catalyst 18 in the removal arm 11 is more than 15 cm in the example shown in FIG. 2. In principle, however, a flow path L of the laser gas 4 of more than 5 cm or of more than 10 cm may be sufficient for reducing deposition of the degradation products on the respective catalyst 18.

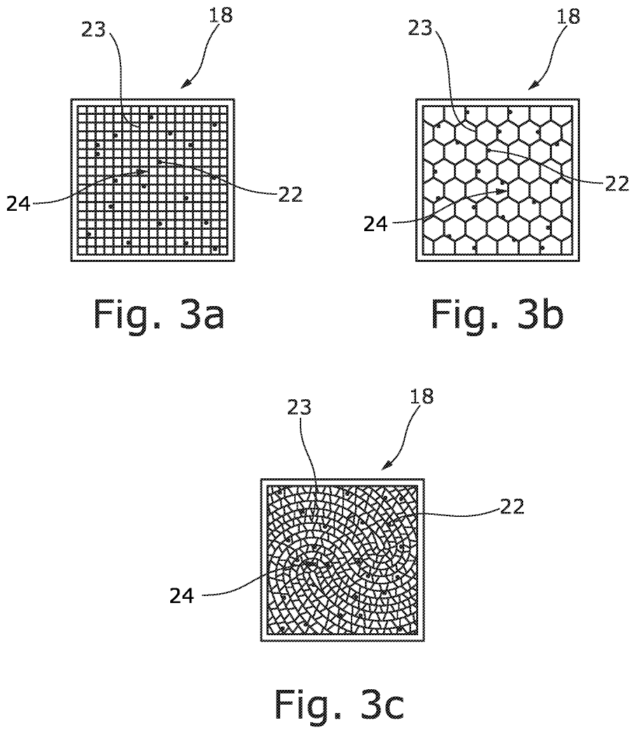

As can also be seen in FIG. 2, the supply arms 8 and removal arms 11 each comprise a closable opening 21 as a device for replacing the catalysts 18. The openings 21 can be closed, for example, by means of plates or flaps which are detachable or pivotable. The catalysts 18 are in the form of separate components in the form of cassettes, which considerably facilitates replacement thereof. FIG. 3a,b,c schematically illustrate cross-sections of cuboid catalysts 18 in the form of replaceable cassettes. The catalysts each comprise precious metal nanoparticles 22 and a substrate 23. Present on the substrate 23 is a coating 24 to which the precious metal nanoparticles 22 are applied. The coating 24 comprises aluminum oxide, but it can also comprise a different metal oxide, for example cerium oxide, titanium oxide, copper oxide or a mixture of these materials. Alternatively, the substrate 23 can also be uncoated. In this case, the precious metal nanoparticles 22 are directly applied to the substrate 23.

For ease of illustration, FIG. 3a,b,c only show isolated precious metal nanoparticles 22. In the example shown, the precious metal nanoparticles 22 are gold nanoparticles. However, the precious metal nanoparticles 22 can also be platinum nanoparticles, palladium nanoparticles, nanoparticles of an alloy of these materials, or a mixture of these nanoparticles or of these nanoparticles with gold nanoparticles. The substrates 23 are structured for surface area enlargement in order to increase the turnover of the catalysts 18. Alternatively or additionally, the coating 24 can also be microscopically structured for surface area enlargement.

The substrate 23 of the catalyst 18 shown in FIG. 3a is a pultruded cordierite substrate, but it can also be a different ceramic substrate. The cross-section of the catalyst 18 has a square pattern.

In FIG. 3b,c, the substrates 23 are metal substrates, more precisely steel substrates. In FIG. 3b, the structure is a honeycomb structure for surface area enlargement. In FIG. 3c, the substrate 23 is a rolled-up corrugated sheet or corrugated foil.

As an alternative or in addition to the catalysts 18 in the form of replaceable catalyst cassettes shown in FIG. 3a-c, at least one inner face of at least one supply arm 8 and/or removal arm 11 in contact with the laser gas 4 can serve as substrate 23 for one or more catalysts 18. In addition, a coating, for example ceramic coating, can be applied to the inner face of the respective supply or removal arm 8,11, which coating forms the substrate 23 for the precious metal nanoparticles 22.

Before fitting the catalysts 18 in the CO₂ beam source 1, they should be cleaned carefully. In the present case, this is important because the laser gas circuit K is closed. Suitable here are primarily mechanical dry methods, for example blow-off with nitrogen, wet methods (using H2O+x) or ultrasonic cleaning. If necessary, further baking and activation steps can be performed. In addition, when designing the catalysts 18, a balance can be made between the pressure loss caused by the catalysts 18, the cooling effect of the heat exchangers and the effectiveness of the catalysts 18. To this end, the structure of the substrates 23 of the catalysts 18 and the essential geometrical parameters, including the cross-sections, the rib spacings, the length, etc., can be optimized. In addition, when selecting the catalysts 18, care should be taken to ensure that parasitic effects do not occur, for example “poisoning” of the active sites, which are then no longer active, or temperature-dependent absorption (CO₂, H2O), which can lead to undesired changes in the laser gas composition. The catalyst 18 should not be overdimensioned in order to avoid the introduction of catalyst material which merely leads to parasitic effects and does not contribute to catalysis. In particular, the catalyst 18 should not have any surfaces to which there is no flow and which thus only act parasitically instead of contributing to catalysis or should have as few of such surfaces as possible. The layer thickness of the coating 24 and the materials of the precious metal nanoparticles 22 and of the coating 24 can also thus be optimized.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A CO₂ beam source comprising:
at least one discharge tube in which a laser gas serves as a laser medium,
a fan for supplying the laser gas into the at least one discharge tube via at least one supply element and for removing the laser gas from the at least one discharge tube via at least one removal element in a closed laser gas circuit, and
at least one catalyst for catalysing oxidation of dissociation products that are formed upon excitation of the laser gas, wherein the at least one catalyst comprises precious metal nanoparticles applied to a substrate,
wherein
the at least one catalyst is arranged with clearance from the at least one discharge tube in the flow direction of the laser gas within the closed laser gas circuit in order to reduce deposition of degradation products formed in the at least one discharge tube upon excitation of the laser gas compared to an arrangement within the at least one discharge tube, and a temperature of the at least one catalyst during operation of the CO₂ beam source is at least 60° C.

2. The CO₂ beam source as claimed in claim 1, wherein a flow path of the laser gas between a downstream end of the at least one discharge tube and the at least one catalyst is at least 5 cm.

3. The CO₂ beam source as claimed in claim 2, wherein the flow path of the laser gas between the downstream end of the at least one discharge tube and the at least one catalyst is at least 10 cm.

4. The CO₂ beam source as claimed in claim 2, wherein the flow path of the laser gas between the downstream end of the at least one discharge tube and the at least one catalyst is at least 15 cm.

5. The CO₂ beam source as claimed in claim 1, wherein the at least one catalyst is arranged within the at least one supply element.

6. The CO₂ beam source as claimed in claim 1, wherein the fan is centrally arranged and wherein, in a first plane, the CO₂ beam source comprises supply arms as first supply elements and removal arms as second removal elements in a radial and alternating manner and, in a second plane, the discharge tubes are interconnected via second supply elements and first removal elements in an alternating manner, and wherein at least one partial region of at least one supply arm of the supply arms and/or at least one removal arm of the removal arms is in a form of a heat exchanger for cooling of the laser gas.

7. The CO₂ beam source as claimed in claim 6, wherein at least one inner face of at least one supply arm in contact with the laser gas serves as the substrate of the at least one catalyst.

8. The CO₂ beam source as claimed in claim 6, wherein the at least one catalyst is arranged in at least one of the supply arms and/or in at least one of the removal arms upstream of the at least one partial region in the form of the heat exchanger.

9. The CO₂ beam source as claimed in claim 1, wherein the CO₂ beam source comprises at least one device for replacing the at least one catalyst.

10. The CO₂ beam source as claimed in claim 9, wherein at least one supply arm and/or at least one removal arm comprises at least one closable opening as the at least one device for replacing the at least one catalyst.

11. The CO₂ beam source as claimed in claim 1, wherein the precious metal nanoparticles comprise:
platinum nanoparticles, palladium nanoparticles, gold nanoparticles, nanoparticles of an alloy of these materials, or a mixture of thereof.

12. The CO₂ beam source as claimed in claim 1, wherein the substrate of the at least one catalyst is a metal substrate or a ceramic substrate.

13. The CO₂ beam source as claimed in claim 1, wherein a coating is present on the substrate of the at least one catalyst and the precious metal nanoparticles are applied to the coating, wherein the coating comprises a metal oxide.

14. The CO₂ beam source as claimed in claim 13, wherein the coating comprises cerium oxide, aluminum oxide, titanium oxide, copper oxide, or a mixture thereof.

15. The CO₂ beam source as claimed in claim 13, wherein the coating on the substrate of the catalyst is microscopically structured for surface area enlargement.

16. The CO₂ beam source as claimed in claim 1, wherein the substrate of the catalyst is structured for surface area enlargement.

17. The CO₂ beam source as claimed in claim 16, wherein the substrate of the catalyst is honeycomb-structured for surface area enlargement.

18. The CO₂ beam source as claimed in claim 1, wherein the temperature of the at least one catalyst during operation of the CO₂ beam source is at least 100° C.

19. The CO₂ beam source as claimed in claim 18, wherein the temperature of the at least one catalyst during operation of the CO₂ beam source is at least 150° C.
